(19) United States
(12) Patent Application Publication
(10) Pub. No.: US 2014/0022097 A1
(43) Pub. Date: Jan. 23, 2014

(54) SINGLE-WIRE KEYPAD MODULAR STRUCTURE

(71) Applicant: Cheng-Yi TSAI, New Taipei City (TW)

(72) Inventor: Cheng-Yi TSAI, New Taipei City (TW)

(21) Appl. No.: 13/942,224

(22) Filed: Jul. 15, 2013

(30) Foreign Application Priority Data
Jul. 19, 2012 (TW) 101213966

(51) Int. Cl. G06F 3/023

(52) U.S. Cl. CPC G06F 3/023
USPC 341/26

(57) ABSTRACT

A single-wire keypad modular structure provided with keys used in electronics device and comprising: a keypad module and a data signal transformation module; and said keypad module further comprising a number of resistances electrically connected to each other in series and a number of keys electrically connected to each other in parallel wherein (1) each of the keys links a live end and a ground end and is situated between two resistances for forming a voltage change between distinct keys and (2) the live ends are electrically connected to each other; a data signal transformation module which is based on single-wire input circuits for electrically connecting the keypad module's ground end and transform the changed input voltages to digital data signals and output to a control module for execution of corresponding functions when any of the keys is pressed down.

### BACKGROUND OF THE INVENTION

1. Field of the Invention

The present invention relates to keys used in electronics, particular a keypad modular structure with moderate wirings staggered inside and convenient aesthetic wiring layouts designed in electronics device.

2. Description of the Related Art

In general, electronics device available in the market have designs of keypad interfaces. It is common for these relevant products to directly install an operator panel with keys which are electrically connected to a control module via multiple wirings for activating electrical functions. As shown in FIG. 1, a keypad module 100 is provided with a plurality of keys 101 (SW1˜SWn), each of which links a live end 101a and a ground end 101b: the live ends 101a are electrically connected in parallel; each of the ground ends 101b links an output line 101c and further a control module 200 which is used to check and process any data signal entered through any of the keys 101 (SW1˜SWn) for execution of a corresponding function or control. However, it is not practical to additionally design output lines 101c linking all keys 101 (SW1˜SWn) due to resource waste and cost of man-hours in manufacture.

As shown in FIG. 2, a common solution is based on (a) matrix wiring and line-by-line scanning to check the columns in which one of the keys 101 (SW1˜SW9) was pressed down and (b) a computer program to find the corresponding key value.

In the era of most electronics device designed as compact styles, some issues still need corresponding solutions, for example, insufficient space for hardware design, unsystematic staggered wirings, and needs to prevent outside Electro-Static Discharge (ESD) directly coming from input terminals of multiple keys; resulting in failures of the keys 101, even causing a damage of input circuits in the control module 200, as such leading to a crash of electronics device. Accordingly, the drawbacks in terms of a conventional keypad need to be overcome by persons skilled in the art.

Having considered defects and unideal structural design of wirings in a conventional keypad module for a long period, the inventor offered a solution and manufactured the present invention of a single-wire keypad modular structure for the general public and development of the industry.

### SUMMARY OF THE INVENTION

The object of the present invention is to provide a single-wire keypad modular structure which avoids problems such as limited space for hardware design and unsystematic staggered wirings, actively promoting economic efficiency in manufacture and product competitiveness.

The other object of the present invention is to avoid direct Electro-Static Discharge (ESD) which comes from input terminals of multiple keys and results in failures of the functions of keys, damage of input circuits of a control module 200, and crash of electronics device.

The further object of the present invention is to provide a modular keypad applicable to X86 PCs and Advanced RISC Machine (ARM)/Reduced Instruction Set Computer (RISC) embedded devices, for instance, embedded panel PC, Point of Sale (POS) system, Human Machine Interface (HMI), server system, IT products in a factory automation system, or customized devices matching specific input demands via diversified keys.

For the above purposes, the present invention of a single-wire keypad modular structure relies on technical measures comprising a keypad module and a data signal transformation module; the keypad module is further provided with (a) a number of resistances which are electrically connected in series, (b) a number of keys electrically connected to each other in parallel wherein (1) each of the keys links a live end and a ground end and is situated between two of the resistances for forming a voltage change between distinct keys and (2) the live ends are electrically connected to each other.

The data signal transformation module whose one side is based on single-wire input circuits for electrically connecting the ground ends of the keypad module and transforming analogue input voltages received from the key module to digital data signals and the other side is connected to a control module. As such, a distinct output analogue voltage signal triggered by the specific key which was pressed down is sent from the keypad module to the data signal transformation module to be transformed to a digital data signal and then sent to a control module for follow-up processing or execution of a corresponding function or control.

For technical features and effects in terms of the present disclosure completely comprehended and recognized, the preferred embodiments and accompanying drawings are thoroughly described hereinafter.

### BRIEF DESCRIPTION OF THE DRAWINGS

FIG. 1 is a schematic view illustrating circuit architecture of a conventional keypad module.

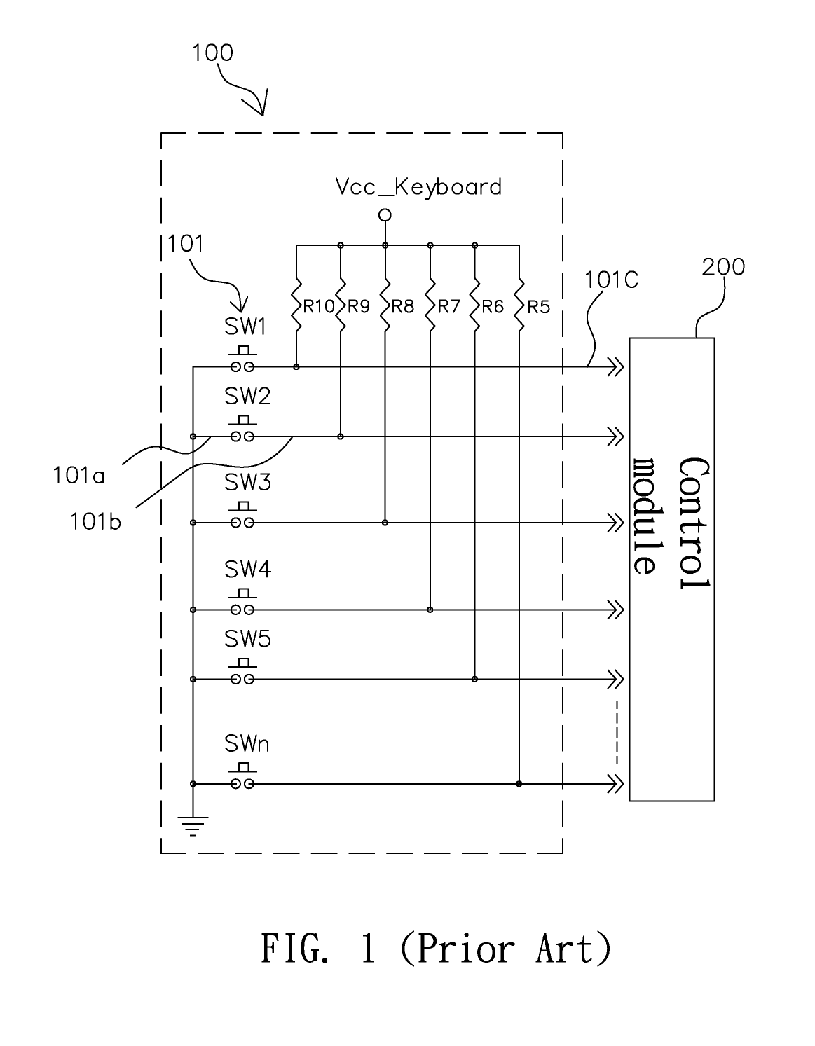

FIG. 2 is another schematic view illustrating circuit architecture of a conventional keypad module.

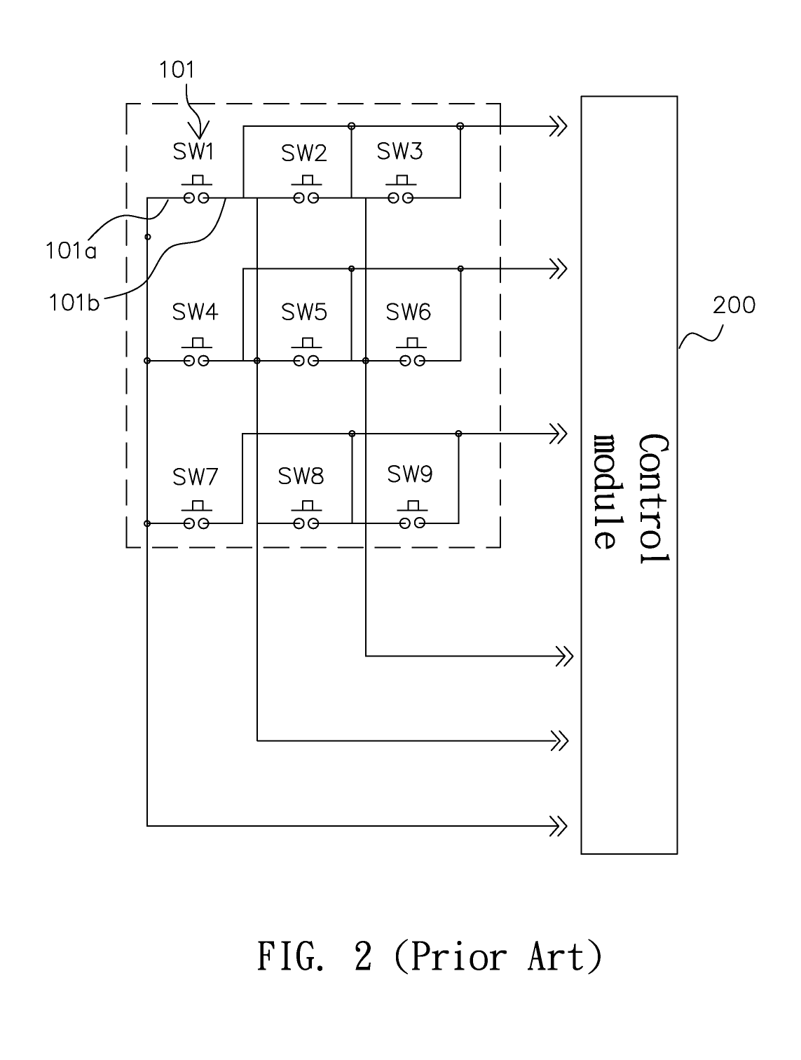

FIG. 3 is a schematic view illustrating circuit architecture of the present invention of a single-wire keypad modular structure.

FIG. 4 is an enlargement view illustrating circuit architecture of a keypad module in the present invention of a single-wire keypad modular structure.

FIG. 5 is an enlargement view illustrating circuit architecture of a data signal transformation module in the present invention of a single-wire keypad modular structure.

### DETAILED DESCRIPTION OF THE PREFERRED EMBODIMENTS

The technical measures and effects for the present invention of a single-wire keypad modular structure are described in preferred embodiments and accompanying drawings hereinafter.

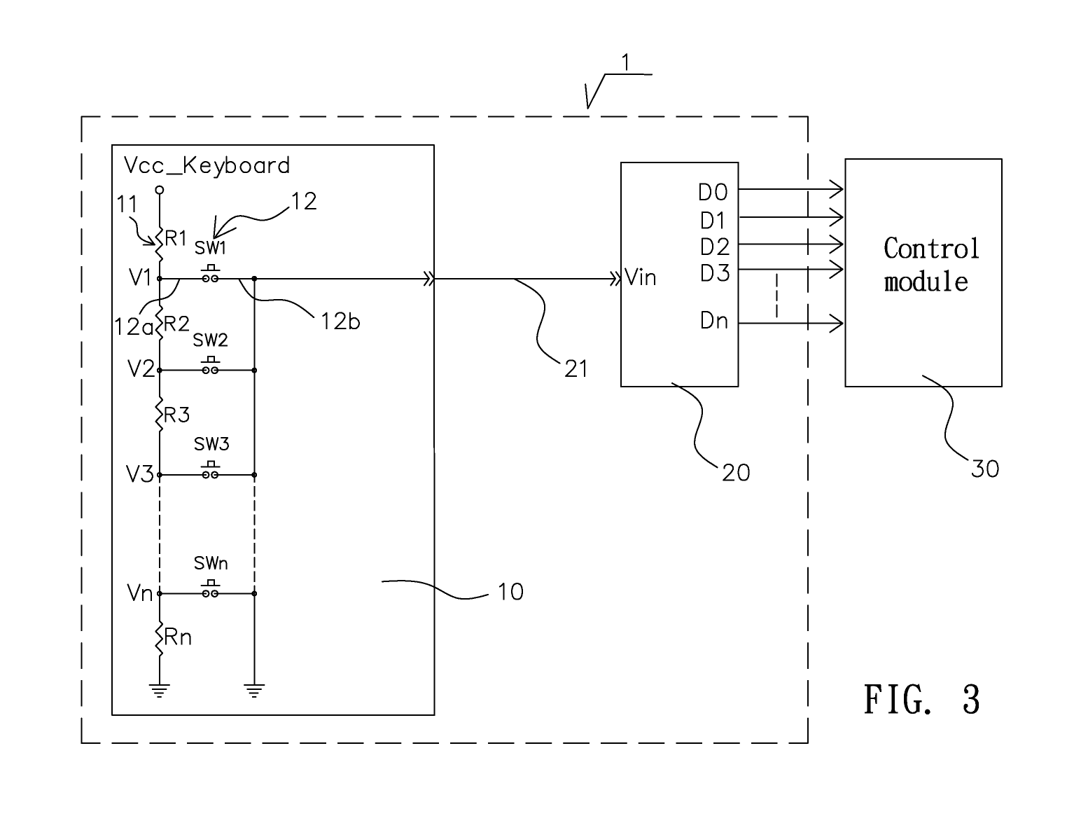

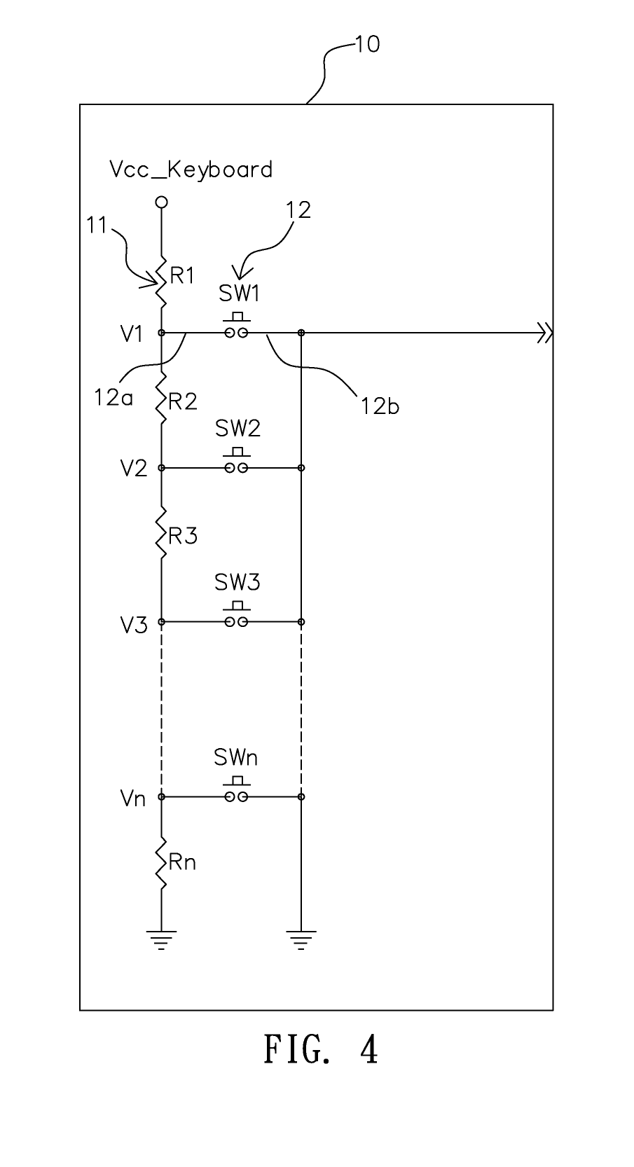

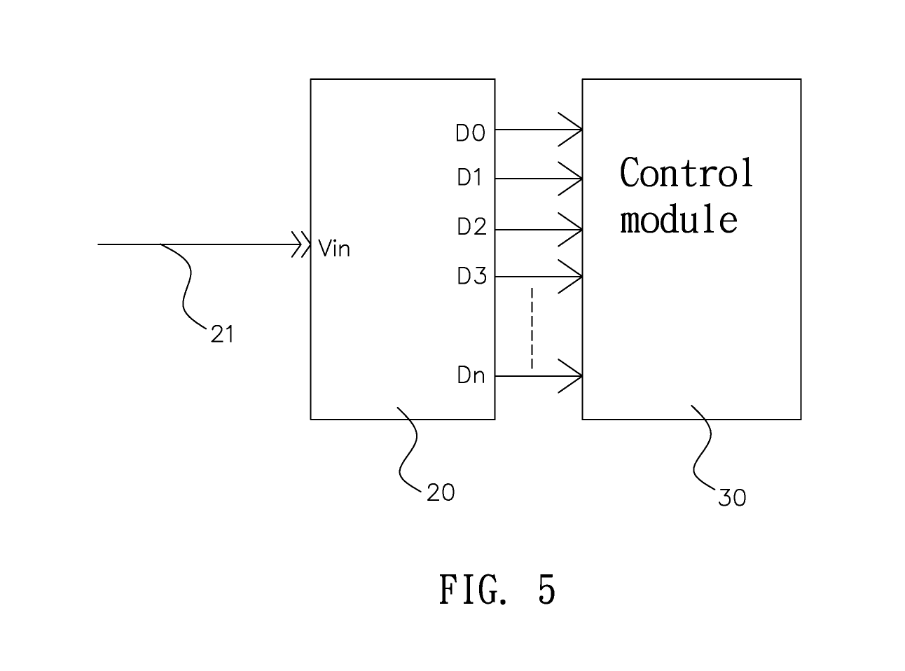

As shown in FIGS. 3-5, the present invention particularly presents a single-wire keypad modular structure 1 used in electronics device and comprising a keypad module 10 and a data signal transformation module 20; and said keypad module is further provided with a number of resistances 11 (R1˜Rn) and a number of keys 12 (SW1˜SWn).

In the present invention, the resistances 11 (R1˜Rn) are electrically connected to each other in series.

Among the keys 12 (SW1˜SWn) which are electrically connected in parallel, each of the keys 12 (SW1˜SWn) links a live end 12a and a ground end 12b and is installed between two of the resistances 11 (R1˜Rn) so that forming a corresponding voltage change (V1˜Vn) between different keys 12 (SW1˜SWn) in the course of electric current conveyed over varying amounts of resistances 11 (R1˜Rn); the distinct live ends 12a linking all keys 12 (SW1˜SWn) are electrically connected to each other.

As an Analog to Digital Converter (ADC) in the embodiment, the data signal transformation module 20 depends on a single-wire architecture of input circuits 21 at one side for electrical connection to the ground ends 12b in the keypad module 10, receiving analogue input voltages Vin (V1˜Vn) from the keys 12 (SW1˜SWn), and transforming the analogue input voltages Vin (V1˜Vn) to digital data signals D0˜Dn.

In the embodiment, the present invention further comprises a control module 30, which is electrically connected to the other side of the data signal transformation module 20 and receives the different digital data signals D0˜Dn to activate follow-up operations and execute corresponding functions or controls.

Refer to the following table for further details:

| Status | Corresponding Key | ADC Input | ADC Output |
|---|---|---|---|
| 1 | None of the keys is pressed down. | V0 | D0 |
| 2 | SW1 | V1 | D1 |
| 3 | SW2 | V2 | D2 |
| 4 | SW3 | V3 | D3 |
| . . . | . . . | . . . | . . . |
| n | SWn | Vn | Dn |

For example, at the moment as one of the keys 12 (SW1) pressed down (Status 2), the output voltage V1 is changed with an input voltage Vcc_Keyboard passing through the resistance R1 and is received by the data signal transformation module 20 (an ADC in the embodiment) as an input voltage V1 in which the input voltage V1 is transformed and output as a digital data signal D1; at the moment as one of the key 12 (SW2) pressed down (Status 3), an output voltage V2 is changed with the input voltage Vcc_Keyboard passing through resistances (R1+R2) in series and is received by the data signal transformation module 20 as an input voltage V2 in which the input voltage V2 is transformed and output as a digital data signal D2; and then the digital data signal D1 or D2 is forwarded to the control module 30 for follow-up processing. As such, the distinct digital data signals D1˜'Dn are transmitted to the control module 30 for corresponding functions when the different keys 12 (SW1˜SWn) are pressed down, for example, motors with specific RPMs can be activated by the control module 30 which refers to the specific digital data signals D1˜Dn in a factory automation system.

In the present invention, the data signal transformation module 20 transforming a changed output voltage V(x) to a digital data signal D(x) implies a corresponding digital data signal D(x) is activated with a single key SW(x) pressed down and is forwarded to the control module 30 in which the data signal D(x) is checked and processed for execution of a corresponding function or control.

Based on design of a single-wire keypad modular structure, the present invention, which facilitates both economic efficiency in manufacture, assembly and application and product competitiveness, gets rid of input protection components installed at all input terminals of keys in a conventional interface device, prevents a system from damage induced by Electro-Static Discharge (ESD) via a data input interface, and reduces demands in front-end protection subassemblies/components for hardware and design costs of parts.

Accordingly, the present invention significantly meets patentability and is applied for the patent. However, the above descriptions are preferred embodiments which do not limit the scope of the present invention; any equivalent change or improvement in shapes, structure or features without departing from spirit of the present invention should be incorporated in claims herein.

What is claimed is:

1. A single-wire keypad modular structure, comprising:
a keypad module and a data signal transformation module; and said keypad module further comprising:
a plurality of resistances which are electrically connected to each other in series; and
a plurality of keys which are electrically connected to each other in parallel wherein (1) each of said keys links a live end and a ground end and is situated between two of said resistances so that different voltages between said keys are formed and (2) said live ends are electrically connected to each other; and
said data signal transformation module which is electrically connected to said keypad module through a single-wire input circuits and transforms said different voltages to digital data signals.

2. The single-wire keypad modular structure according to claim 1 wherein said data signal transformation module is further connected to a control module which receives said digital data signals to activate and execute corresponding functions or controls.

3. The single-wire keypad modular structure according to claim 1 wherein said data signal transformation module is connected to said keypad module and said ground ends thereof.

4. The single-wire keypad modular structure according to claim 1 wherein said data signal transformation module is an Analog to Digital Converter (ADC).
